(19) United States
(12) Patent Application Publication
(10) Pub. No.: US 2003/0084314 A1
(43) Pub. Date: May 1, 2003

(54) Identity verification system

(76) Inventors: Yu-Chen Yang, Taichung Hsien (TW); Chien-Hong Chen, Tali City (TW); Yao-Hung Shen, Yunlin Hsien (TW)

Correspondence Address: BACON & THOMAS, PLLC, 625 SLATERS LANE, FOURTH FLOOR, ALEXANDRIA, VA, 22314

(21) Appl. No.: 09/984,587

(22) Filed: Oct. 30, 2001

(51) Int. Cl. H04L 9/32

(52) U.S. Cl. 713/200

(57) ABSTRACT

An identity verification system has a record medium, a terminal device and a main system device. The record medium records coded verification data. The terminal device reads the coded verification data on the record medium and saves new first coded verification data to the record medium. The main system device is connected to the terminal device. The main system device has decoding means to decode the coded verification data on the record medium to decoded verification data and encoding means to code the decoded verification data to new first coded verification data. The coded verification data on the record medium will be replaced with the new coded verification data generated by the encoding means of the main system device. This can prevent the original verification data from being stolen when the data is being transmitted between the terminal device and the main system device. The fraudulent use of the record medium can be prevented.

### BACKGROUND OF THE INVENTION

1. Field of the Invention

The present invention relates to an identity verification system, and more particularly to an identity verification system that replaces the coded verification data every time the system is operated.

2. Description of Related Art

Currently, cards are widely used in commerce, for example credit cards, fiscal cards, etc. The user of the cards can engage in commercial transactions without cash. To keep the cards from being used fraudulently, an identity verification step is always taken to verify the identy of the user. The conventional method of identity verification is to require that the user provide personal identification number (PIN) or a signature when the user uses a card. However, the original verification data like the user's ID number, the card number or check number is always saved on the card. The original verification data and the password can be stolen. An illegal copy of a card can be made using the stolen original verification data. Therefore, the conventional identity verification step cannot provide adequate protection to the user and the service supplier.

To overcome the shortcomings, the present invention tends to provide an identity verification system to mitigate or obviate the aforementioned problems.

### SUMMARY OF THE INVENTION

The main objective of the invention is to provide an identity verification system that has a record medium, a terminal device and a main system device. The record medium records coded verification data. The terminal device reads the coded verification data on the record medium and saves new first coded verification data on the record medium. The main system device is connected to the terminal device. The main system device has decoding means to decode the coded verification data on the record medium and encoding means to code the verification data to new first coded verification data. The user can be identified by the decoded verification data. The coded verification data on the record medium will be replaced with the new coded verification data generated by the encoding means of the main system device. This can keep the original verification data from being stolen when the verification data is being transmitted between the terminal device and the main system device. In addition, fraudulent use of the record medium can be prevented or immediately stopped.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of an identity verification system in accordance with the present invention;

FIG. 2 is a functional block diagram of the identity verification system in FIG. 1;

FIG. 3 is an operational block diagram of the identity verification system in FIG. 1 showing the replacement of the coded verification data when the identity verification system is in operation; and

FIG. 4 is an operational block diagram of the identity verification system in FIG. 1 showing the replacement of the coded data as the identity verification system is in operation in the next time.

### DETAILED DESCRIPTION OF PREFERRED EMBODIMENT

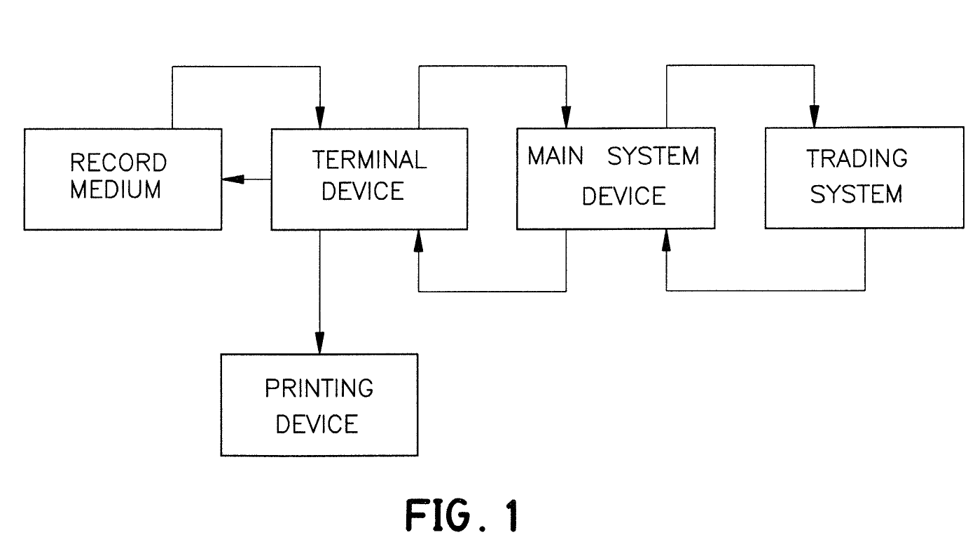

With reference to FIG. 1, an identity verification system in accordance with the present invention comprises a record medium, a terminal device and a main system device. The record medium records coded verification data of a plurality of data items like the user's ID number, the card number or the check password, wherein each coded verification data item is coded by a specific encoding means from one of the data items. In practice, the record medium can be a credit card, a fiscal card or the like. The terminal device is used to read the coded verification data on the record medium and save the coded verification data to the record medium. The terminal device is connected to the main system device through telephone lines or the Internet, such that the terminal device can deliver the coded verification data on the record medium to the main system device. Each terminal device has a specific recognition number different from all others so the main system device can recognize which terminal device is sending verification data to the main system device.

The main system device saves the original verification data of the data items on the record medium. In practice, the main system device saves the original data of the user's ID number, the card number and the check password. The main system device has decoding means to decode the coded verification data to decoded verification data, and the decoded verification data will be correlated with the original verification data to identify the user. The main system further has encoding means for encoding the previously coded verification data or the decoded verification data to new coded verification data.

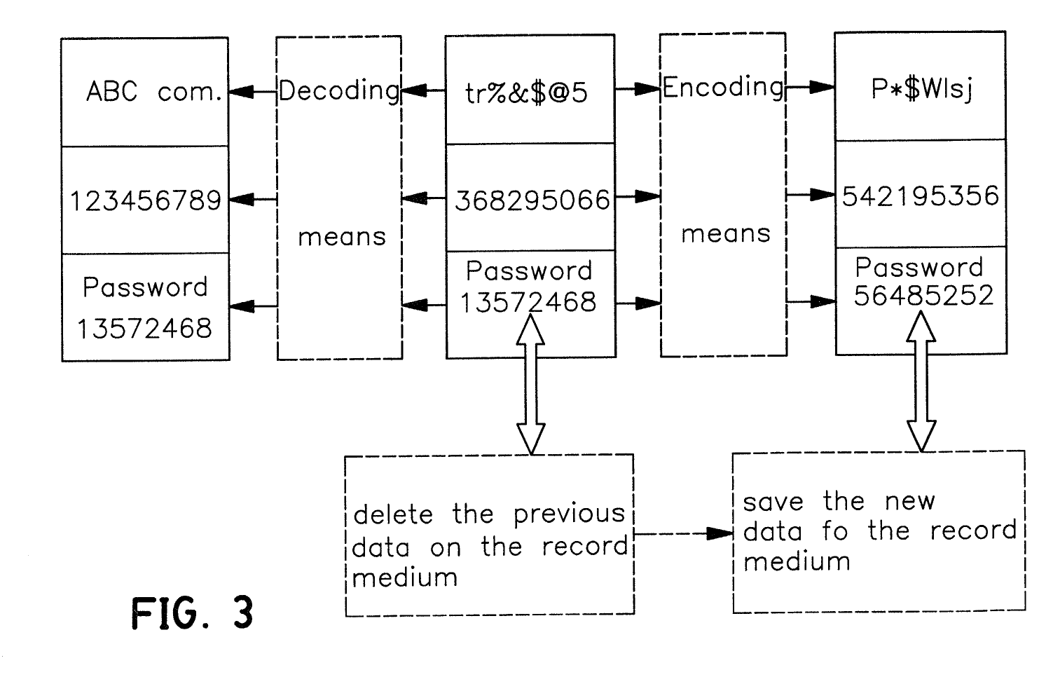

In practice, the user holds the record medium. The terminal device is located in a place where the user wants to use specific commercial or financial service, for example in a store or a bank. The main system device can be located at the service supplier or an independent unit connected to the service supplier. In operation, with reference to FIGS. 1 to 3, the record medium is inserted into the terminal device. The terminal device reads the coded verification data on the record medium, for instance tr%&$@5, 368295066 and 13572468 as shown in the middle column in FIG. 3, and delivers the coded verification data and the recognition number on the terminal device to the main system device. After the main system device receives the coded verification data and the recognition number of the terminal device, the decoding means decodes the coded verification data to decoded verification data such as ABC com., 123456789 and 13572468 as shown in the left column in FIG. 3. The decoded verification data will be compared with the original verification data saved in the main system device to verify the identity of the user. If the decoded verification data is the same as the original verification data, the identity of the user is verified. The main system device will respectively inform the service supplier and the terminal device to allow the user to use the service. If any of the decoded verification data is different from the original item data item, the identity of the user is not verified, and the user's card cannot be used for the service.

After the identity verification step, the encoding means of the main system device codes the previously coded verification data or selectively codes the decoded verification data to new coded verification data such as p*$Wlsj, 542195356 and 56485252 as shown in the right-hand column in FIG. 3 and delivers the new coded verification data to the terminal device. The terminal device will save the new coded verification data on the record medium to replace the previous coded verification data.

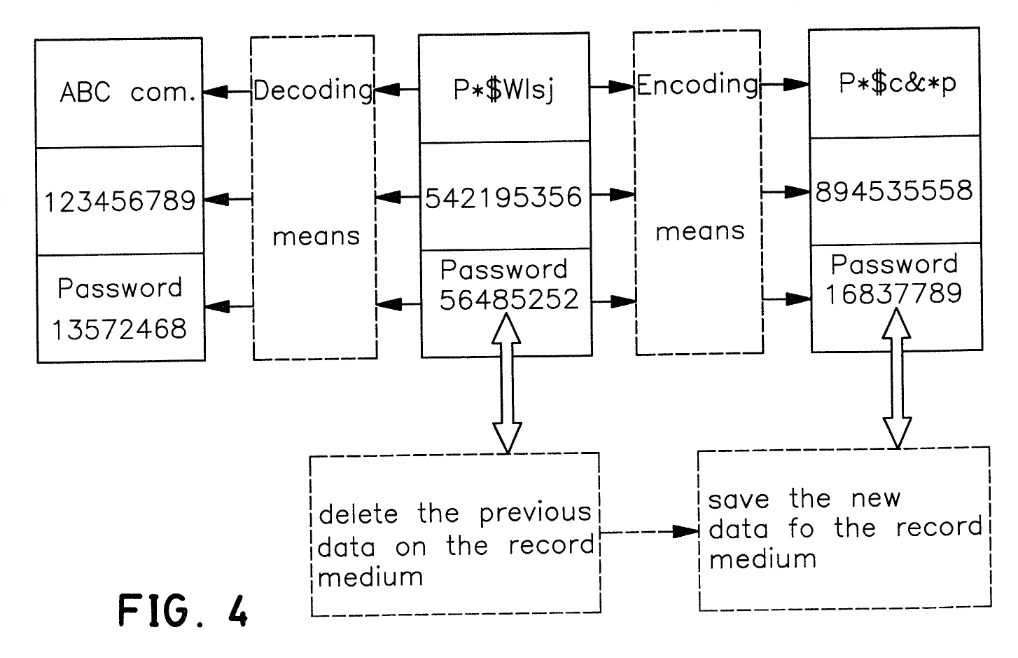

The next time the user wants to use the service, the record medium is inserted into the terminal device. The terminal device reads the coded data on the record medium as p*$Wlsj, 542195356 and 56485252 as shown in the middle column in FIG. 4, and delivers the coded verification data and the recognition number of the terminal device to the main system device. The decoding means decodes the coded verification data to decoded data as ABC com., 123456789 and 13572468 as shown in the left column in FIG. 4 for comparison with the original verification data. After the identity verification step, the encoding means of the main system device codes the coded verification data or the decoded verification data to new coded verification data such as p*$c&*p, 894535558 and 16837789 as shown in the right-hand column in FIG. 4 and delivers the new coded verification data to the terminal device. The new coded verification data will be saved on the record medium to replace the previous verification data.

Accordingly, because the verification data delivered between the terminal device and the main system device are coded verification data but not the original verification data, the coded verification data cannot be determined and used on a counterfeit record medium that has the data same as the original verification data. In addition, when a counterfeit record medium with the coded verification data is made, the counterfeit record medium with the previous coded verification data will not be verified because the coded verification data will be replaced with new verification data after the legal user uses the record medium. Fraudulent use of the record medium can be avoided.

If the counterfeit record medium is used before the legal one and the coded data has been replaced, the legal one with the previous coded verification data will be refused. Consequently, the legal user can immediately know that his or her record medium has been illegal copied. The legal user can immediately inform the service supplier and stop the use of the counterfeit record medium. For the service supplier, the service supplier can track the illegal copier when the counterfeit record medium is used. This can reduce or even prevent monetary loss by both the user and the service supplier.

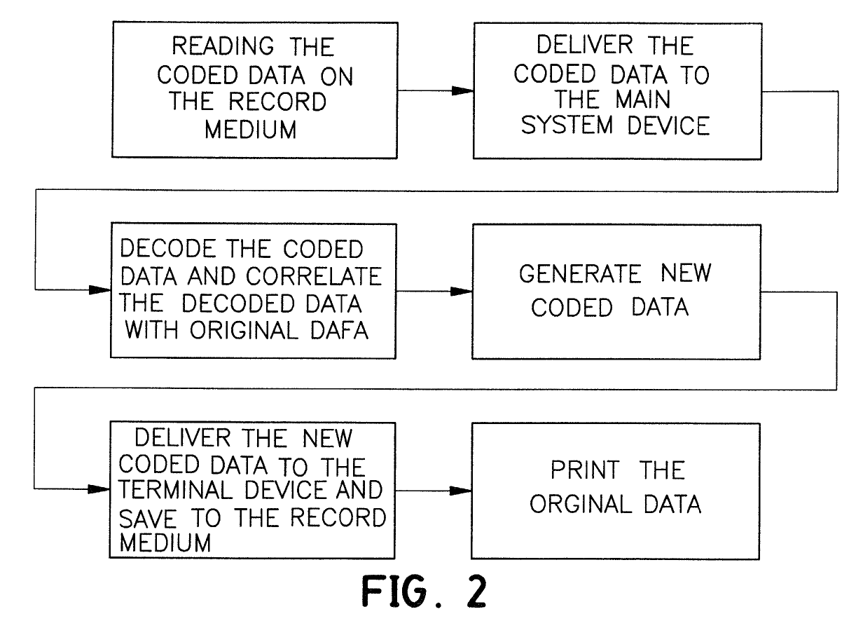

With reference to FIGS. 1 and 2, a printing device is mounted on or connected to the terminal device. The terminal device has a decoding means for decoding specific verification data. When the identity of a user is verified, the encoding means of the main system device will generate coded verification data for printing and a key code based on the recognition number of the terminal device that sends the data to the main system device. The terminal device can decode the coded verification data to the original verification data based on the recognition number of the terminal device and the key code. Consequently, the printing device can then print the original verification data for the user to check. Because the coded verification data for printing is generated based on the recognition number of a specific terminal device, the coded verification data for printing cannot be decoded to the original verification data in a different device.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An identity verification system comprising:
a record medium for recording first coded verification data on the record medium;
a terminal device for reading the first coded verification data on the record medium and saving new first coded verification data to the record medium; and
a main system device connected to the terminal device and having:
first decoding means for decoding the first coded verification data on the record medium to decoded verification data to compare the decoded verification data with the original verification data saved in the main system device; and
encoding means for coding new first coded verification data to replace the previous first coded verification data on the record medium.

2. The identity verification system as claimed in claim 1 further comprising a printing device connected to the terminal device for printing verification data.

3. The identity verification system as claimed in claim 2, wherein the encoding means of the main system device further generates second coded verification data from the original verification data and a key code for the terminal device; and
the terminal device has a second decoding means for decoding the second coded verification data with the key code to the original verification data to print the original verification data from the printing device.

4. The identity verification system as claimed in claim 1, wherein the encoding means generates new first coded verification data from the previous first coded verification data saved on the record medium.

5. The identity verification system as claimed in claim 1, wherein the encoding means generates new first coded verification data from the decoded verification data decoded by the decoding means.
